(19) United States
(12) Patent Application Publication
(10) Pub. No.: US 2016/0188694 A1
(43) Pub. Date: Jun. 30, 2016

(54) CLUSTERS OF POLYNOMIALS FOR DATA POINTS

(71) Applicant: HEWLETT-PACKARD DEVELOPMENT COMPANY, L.P., Houston, TX (US)

(72) Inventors: David Lehavi, Haifa (IL); Sagi Schein, Haifa (IL); Amir Globerson, Haifa (IL); Shai Shalev-Shwartz, Haifa (IL); Roi Livni, Haifa (IL)

(73) Assignee: Hewlett-Packard Development Company, L.P., Houston, TX (US)

(21) Appl. No.: 14/907,610

(22) PCT Filed: Jul. 31, 2013
(86) PCT No.: PCT/US2013/052848

§ 371 Date: Jan. 26, 2016

(51) Int. Cl. G06F 17/30

(52) U.S. Cl. CPC G06F 17/30598; G06F 17/30371; G06F 17/30584

(57) ABSTRACT

A method, system and storage device are generally directed to determining for each of a plurality of data points, a neighborhood of data points about each such data point. For each such neighborhood of data points, a projection set of polynomials is generated based on candidate polynomials. The projection set of polynomials evaluated on the neighborhood of data points is subtracted from the plurality of candidate polynomials evaluated on the neighborhood of data points to generate a subtraction matrix of evaluated resulting polynomials. The singular value decomposition of the subtraction matrix is then computed. The resulting polynomials are clustered into multiple clusters and then partitioned based on a threshold.

### BACKGROUND

In various data classification techniques, a set of tagged data points in Euclidean space are processed in a training phase to determine a partition of the space to various classes. The tagged points may represent features of non-numerical objects such as scanned documents. Once the classes are determined, a new set of points can be classified based on the classification model constructed during the training phase. Training may be supervised or unsupervised.

### BRIEF DESCRIPTION OF THE DRAWINGS

For a detailed description of various illustrative principles, reference will now be made to the accompanying drawings in which:

FIG. 1 shows an example of various classes;

FIG. 2 shows an example of a system in accordance with an implementation;

FIG. 3 shows another example of a system in accordance with an implementation;

FIG. 4 shows yet another example of a system in accordance with an implementation;

FIG. 5 shows a method in accordance with an illustrative example;

FIG. 6 shows an example of multiple data points and a neighborhood of one of the points in accordance with various implementations;

FIG. 7 shows another method in accordance with an illustrative example;

FIG. 8 shows a method that implements a portion of the method of FIG. 7 shows in accordance with an illustrative example;

FIG. 9 shows another method shows in accordance with an illustrative example; and

FIG. 10 shows a method that implements a portion of the method of FIG. 9 in accordance with an illustrative example.

### DETAILED DESCRIPTION

In accordance with various implementations, numbers are extracted from non-numerical data so that a computing device can further analyze the extracted numerical data and/or perform a desirable type of operation on the data. The extracted numerical data may be referred to as “data points” or “coordinates.” A type of technique for analyzing the numerical data extracted from non-numerical data includes determining a unique set of polynomials for each class of interest and then evaluating the polynomials on a set of data points. For a given set of data points, the polynomials of one of the classes may evaluate to 0 or approximately 0. Such polynomials are referred to as “approximately-zero polynomials.” The data points are then said to belong to the class corresponding to those particular polynomials.

All references herein to determining whether a polynomial evaluates to zero includes determining whether a polynomial evaluates to approximately zero (e.g., within a tolerance parameter).

Measurements can be made on many types of non-numerical data (also referred to as data features). For example, in the context of alphanumeric character recognition, multiple different measurements can be made for each alphanumeric character encountered in a scanned document. Examples of such measurements include the average slope of the lines making up the character, a measure of the widest portion of the character, a measure of the highest portion of the character, etc. The goal is to determine a suitable set of polynomials for each possible alphanumeric character. Thus, capital A has a unique set of polynomials, B has its own unique set of polynomials, and so on. Each polynomial is of degree n (n could be 1, 2, 3, etc.) and may use some or all of the measurement values as inputs.

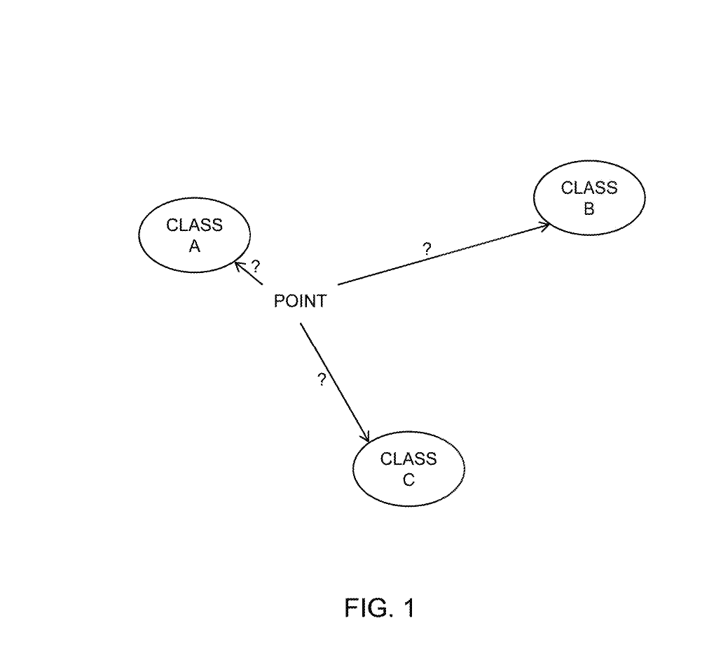

FIG. 1 illustrates an example of three classes-Class A, Class B, and Class C. A unique set of polynomials has been determined to correspond to each class. A data point also is shown. The data point may actually include multiple data values. The goal is to determine to which class the data point belongs. The determination is made by plugging the data point into the polynomials of each class and determining which set of polynomials evaluates to near 0. The class corresponding to the set of polynomials that evaluates to near 0 is the class to which the data point is determined to correspond.

The classes depicted in FIG. 1 might correspond to the letters of the alphabet. For the letter A, for example, if the measurements (data points or coordinates) are plugged into the polynomials for the letter A, the polynomials evaluate to 0 or close to 0, whereas the polynomials for the other letters do not evaluate to 0 or approximately 0. So, a system encounters a character in a document, makes the various measurements, plugs those data points (or at least some of them) into each of the polynomials for the various letters, and determines which character's polynomials evaluate to 0. The character corresponding to that polynomial is the character the system had encountered.

Part of the analysis, however, is determining which polynomials to use for each alphanumeric character. A class of techniques called Approximate Vanishing Ideal (AVI) may be used to determine polynomials to use for each class. The word “vanishing” refers to the fact that a polynomial evaluates to 0 for the right set of input coordinates. Approximate means that the polynomial only has to evaluate to approximately 0 for classification purposes. Many of these techniques, however, are not stable. Lack of stability means that the polynomials do not perform well in the face of noise. For example, if there is some distortion of the letter A or extraneous pixels around the letter, the polynomial(s) for the letter A may not at all vanish to 0 even though the measurements were made for a letter A. Some AVI techniques are based on a pivoting technique which is fast but inherently unstable.

The implementations discussed below are directed to a Stable Approximate Vanishing Ideal (SAVI) technique which, as its name suggests, is stable in the face of noise in the input data. The techniques described herein are further able to model data points that sit on a union of multiple varieties, that is, data points corresponding to multiple classes that are generally indivisible and thus difficult to divide into individual training data sets.

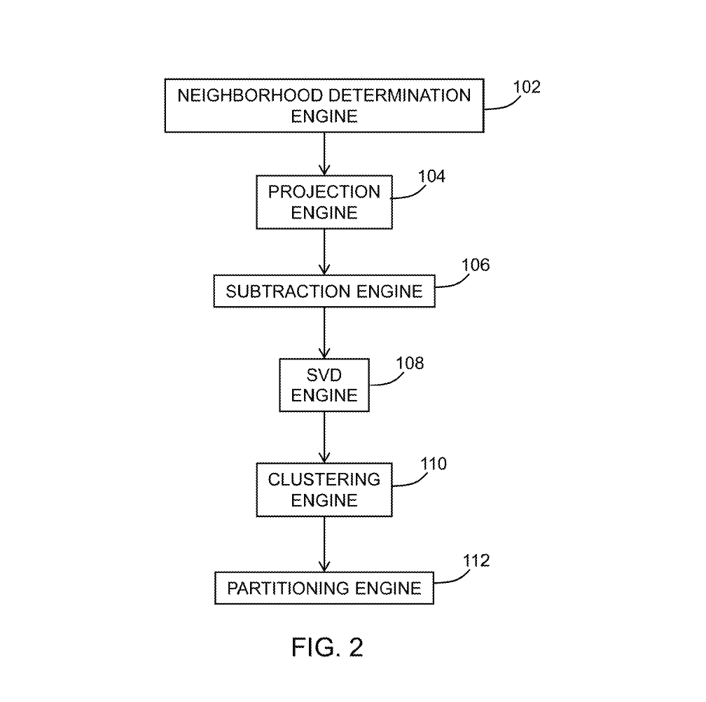

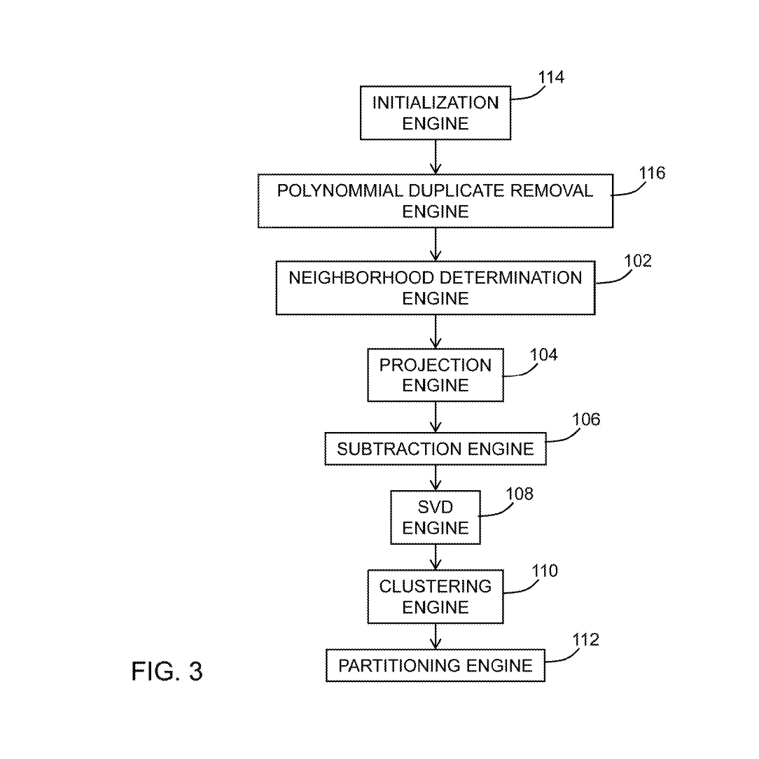

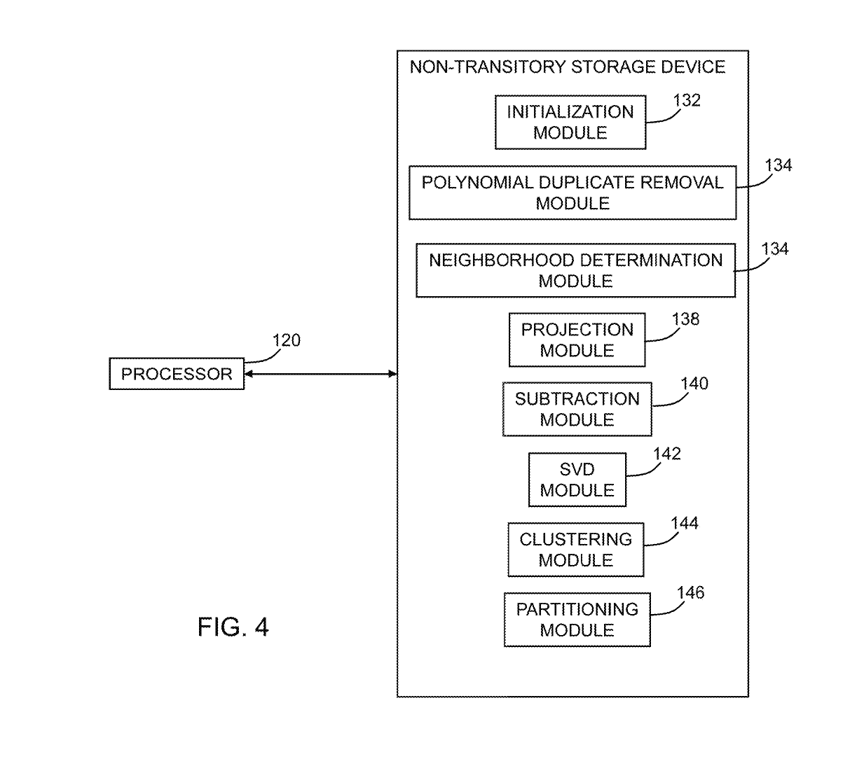

FIG. 2 illustrates a system which includes various engines-a neighborhood determination engine 102, a projection engine 104, a subtraction engine 106, a singular value decomposition (SVD) engine 108, a clustering engine 110, and a partitioning engine 112. In some examples (e.g., the example of FIG. 4, discussed below), each engine 102-112 (as well as the additional engines disclosed of FIG. 3 herein) may be implemented as a processor executing software. The functions performed by the various engines are described below.

FIG. 3 shows another example of a system that has some of the same engines as the system of FIG. 2 but includes additional engines as well. In addition to engines 102-112, the system of FIG. 3 includes an initialization engine 114 and a polynomial duplication removal engine 116.

FIG. 4 illustrates a processor 120 coupled to a non-transitory storage device 130. The non-transitory storage device 130 may be implemented as volatile storage (e.g., random access memory), non-volatile storage (e.g., hard disk drive, optical storage, solid-state storage, etc.) or combinations of various types of volatile and/or non-volatile storage.

The non-transitory storage device 130 is shown in FIG. 4 to include a software module that corresponds functionally to each of the engines of FIGS. 2 and 3. The software modules include an initialization module 132, a polynomial duplicate removal module 134 a neighborhood determination module 136, a projection module 138, a subtraction module 140, an SVD module 142, a clustering module 144, and a partitioning module 146. Each engine of FIG. 2 may be implemented as the processor 120 executing the corresponding software module of FIG. 3.

The distinction among the various engines 102-116 and among the software modules 132-146 is made herein for ease of explanation. In some implementations, however, the functionality of two or more of the engines/modules may be combined together into a single engine/module. Further, the functionality described herein as being attributed to each engine 102-116 is applicable to the software module corresponding to each such engine (when executed by processor 120), and the functionality described herein as being performed by a given module (when executed by processor 120) is applicable as well as to the corresponding engine.

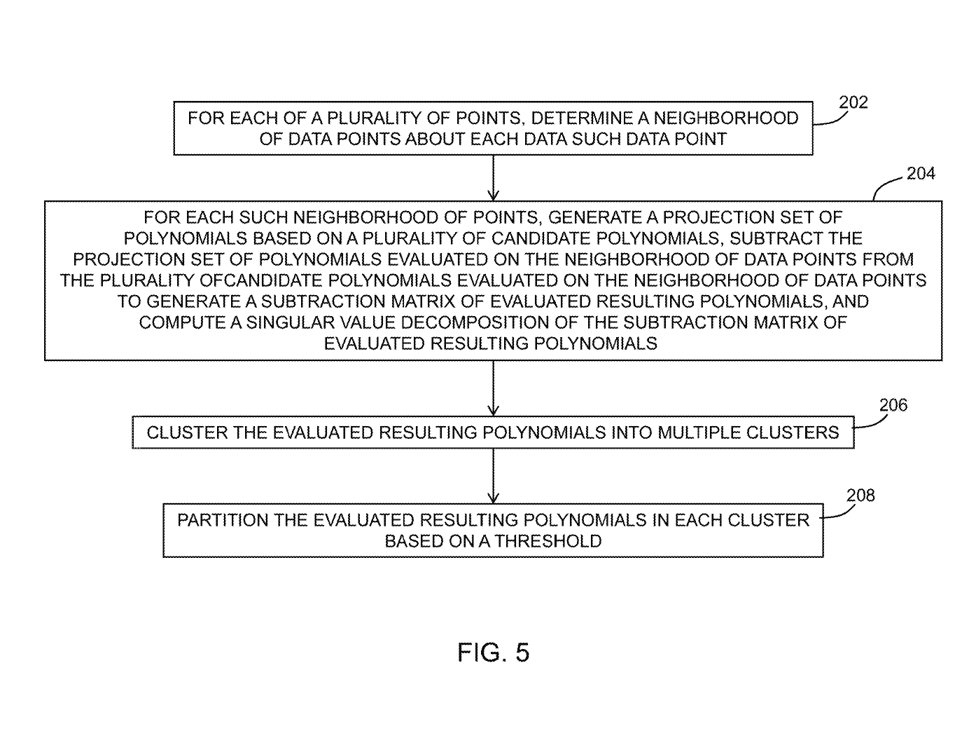

The functions performed by the various engines 102-112 of FIG. 2 will now be described with reference to the flow diagram of FIG. 5. The method of FIG. 5 determines the approximately-zero polynomials for each of multiple classes based on input data points that correspond to the various classes. The input data points, however, cannot be readily divided into groups corresponding to the various classes and thus are processed by the method of FIG. 5 in toto.

The method of FIG. 5 processes a plurality of data points. The data points include multiple subsets of data points, each subset of data points being characteristic of a separate class (e.g., classes A-C as in FIG. 1). The method of FIG. 5 refers to “candidate” polynomials. A candidate polynomial is a polynomial that is to be evaluated per the method FIG. 5 to determine if the polynomial evaluates to zero for the subset of data points. The candidate polynomials represent the polynomials that will be processed in the example method of FIG. 5 to determine which, if any, of the polynomials evaluate on the subset of data points to zero (e.g., below a threshold). Those candidate polynomials that evaluate on the subset of data points to less than the threshold are chosen as polynomials for classifying future data points to a particular class.

A polynomial is a sum of multiple monomials, and each monomial has a particular degree (the monomial 2X̂3 is a degree 3 monomial). The degree of a polynomial is the maximum degree of any of the constituent monomials comprising the polynomial. Operations 202 and 24 of FIG. 5 may first be performed for degree 1 polynomials and then repeated for higher degree polynomials (e.g., degree 2, degree, and so on) before moving on to operations 206 and 208

At 202, the method comprises, for each of the plurality of data points, determining a neighborhood of data points about each such data point, and may be performed by neighborhood determination engine 102. The neighborhood of data points about the particular data point are data points that are “close to” the data point, for example, points that are within a predefined threshold distance from the data point. The threshold distance may be user-specified.

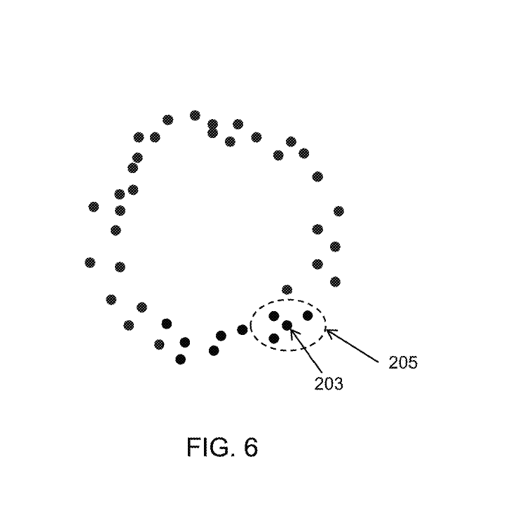

FIG. 6 shows an example of multiple data points. Dashed oval 205 is drawn about data point 203 to illustrate the neighborhood of points about point 205.

At 204, a SAVI technique is performed on each such neighborhood of data points. More specifically, for each such neighborhood of points, the method includes the following operations, which are further described below:
generating a projection set of polynomials based on a plurality of candidate polynomials,
subtracting the projection set of polynomials evaluated on the neighborhood of data points from the plurality of candidate polynomials evaluated on the neighborhood of data points to generate a subtraction matrix of evaluated resulting polynomials, and
computing a singular value decomposition of the subtraction matrix.

Generating the projection set of polynomials may be performed by the projection engine 104. The projection engine 104 may process the set of candidate polynomials to generate a projection set of polynomials by, for example, computing a projection of a space linear combination of the candidate polynomials of degree d on polynomials of degree less than d that do not evaluate to 0 on the set of points. In the first iteration of operations 202 and 204 of FIG. 5, d is 1 but in subsequent iterations of operations 202 and 204, d is incremented (2, 3, etc.). In the first pass with d equal to 1, the polynomials of degree less than d (i.e., degree 0) that do not evaluate to 0 on the set of points are represented by a scalar value such as 1/sqrt(number of points), where “sqrt” refers to the square root operator.

For the initial data point for which a neighborhood is determined and the operations of 202 and 204 are performed, the candidate polynomials are predetermined. For each subsequent data point, the candidate polynomials used in operations 202, 204 are the resulting polynomials generated by operations 202 and 204 being performed on the preceding data point.

The following is an example of the computation of the linear combination of the candidate polynomials of degree d on the polynomials of degree less than d that do not evaluate to 0 on each neighborhood of data points. The projection engine 104 may multiply the polynomials of degree less than d that do not evaluate to 0 by the polynomials of degree less than d that do not evaluate to 0 evaluated on the neighborhood of data points and then multiply that result by the candidate polynomials of degree d evaluated on the neighborhood of data points. In one example, the projection engine 104 computes:

E_{d}=O_{<d}O_{<d}(P)^{t}C_{d}(P)

where O_{<d} represents the set polynomials that do not evaluate to 0 and are of lower than order d, O_{<d}(P)^{t} represents the transpose of the matrix of the evaluations of the O_{<d} polynomials, and C_{d}(P) represents the evaluation of the candidate set of polynomials on the neighborhood of data points (P). E_{d} represents the projection set of polynomials evaluated on the neighborhood of data points.

Generating the subtraction matrix may be performed by the subtraction engine 106. The subtraction engine 106 subtracts the projection set of polynomials evaluated on the neighborhood of data points from the candidate polynomials evaluated on the neighborhood of data points to generate a subtraction matrix of evaluated polynomials, that is:

Subtraction matrix=C_{d}(P)−E_{d}(P)

The subtraction matrix represents the difference between evaluations of polynomials of degree d on the data points within the neighborhood, and evaluations of polynomials of lower degrees on such data points.

The SVD engine 108 computes the singular value decomposition of the subtraction matrix. The SVD of the subtraction matrix may result in the three matrices U, S, and V^{t}. U is a unitary matrix. S is a rectangular diagonal matrix in which the values on the diagonal are the singular values of the subtraction matrix. V^{t} is the transpose of a unitary matrix and thus also a unitary matrix. That is:

Subtraction matrix=USV*

A matrix may be represented as a linear transformation between two distinct spaces. To better analyze the matrix, rigid (i.e., orthonormal) transformations may be applied to the space. The “best” rigid transformations may be the ones which will result in the transformation being on a diagonal of a matrix, and that is exactly what the SVD achieves. The values on the diagonal of the S matrix are called the “singular values” of the transformation.

For each neighborhood of data points, operation 204 results in one or more evaluated resulting polynomials (e.g., a unique set of polynomials for each data point neighborhood). Neighborhoods of data points that have similar polynomials are likely to be part of the same class. As such, at 206, the method includes clustering (206) the evaluated resulting polynomials into multiple clusters to cluster the various data points into the various classes. The clustering operation may be performed by the clustering engine 110. Any of a variety of clustering algorithms may be used.

At 208, for each cluster of data points, the method includes partitioning the evaluated resulting polynomials based on a threshold. The partitioning engine 112 partitions the polynomials resulting from the SVD of the subtraction matrix based on a threshold. The threshold may be preconfigured to be 0 or a value greater than but close to 0. Any polynomial that results in a value on the points less than the threshold is considered to be a polynomial associated with the class of points being learned, while all other polynomials then become the candidate polynomials for the subsequent iteration of the SAVI process.

In one implementation, the partitioning engine 112 sets U_{d} equal to (C_{d}−E_{d})VS⁻¹ and then partitions the polynomials of U_{d} according to the singular values to obtain G_{d} and O_{d}. G_{d} is the set of polynomials that evaluate to less than the threshold on the points. O_{d} is the set of polynomials that do not evaluate to less than the threshold on the points.

The partitioning engine 112 also may increment the value of d, multiply the set of candidate polynomials in degree d−1 that do not evaluate to 0 on the points by the degree 1 candidate polynomials that do not evaluate to 0 on the points. The partitioning engine 110 further computes D_{d}=O₁×O_{d-1} and then sets the candidate set of polynomials for the next iteration of the SAVI process to be the orthogonal complement in D_{d} of span ∪ᵢ₌₁^{d-1}Gᵢ×O_{d-i}.

The results of the process of FIG. 5 are multiple sets of approximately-zero polynomials, each set describing a unique class. In the 3-class example of FIG. 1, the method of FIG. 5 would result in three sets of approximately-zero polynomials.

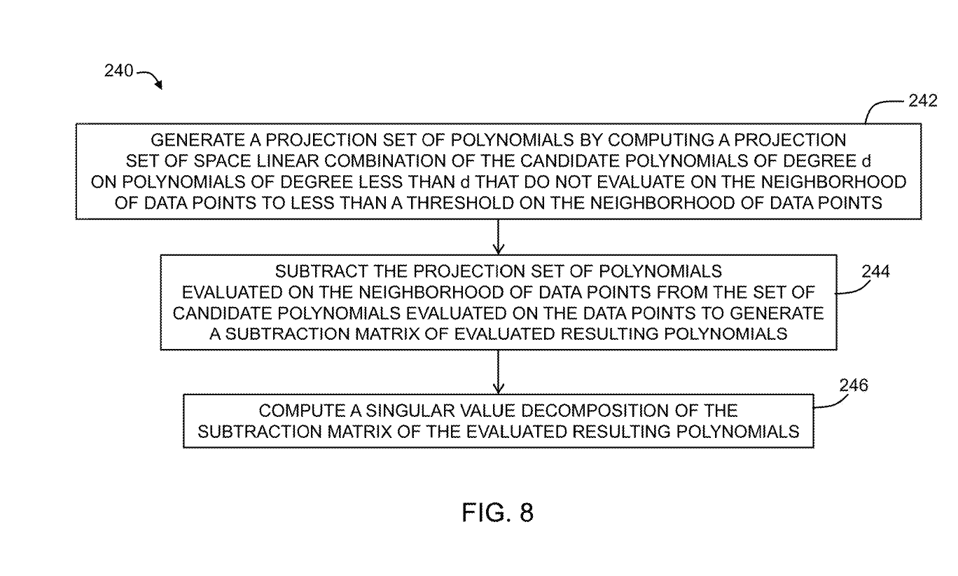

FIG. 8 illustrates another example of a method implementation. At 220, the method includes selecting an initial data point (p). This operation may be performed by initialization engine 114 (FIG. 3). The plurality of data points being processed is referred to as P and each constituent data point within P is referred to as p (upper case P refers to the entire set of data points and lower case p refers to an individual data point). The first point p selected and it is not important which point is selected first.

At 222, the method includes initializing the candidate polynomials. This operation also may be performed by the initialization engine and may include initializing the dimension to 1 to begin the process with dimension 1 polynomials.

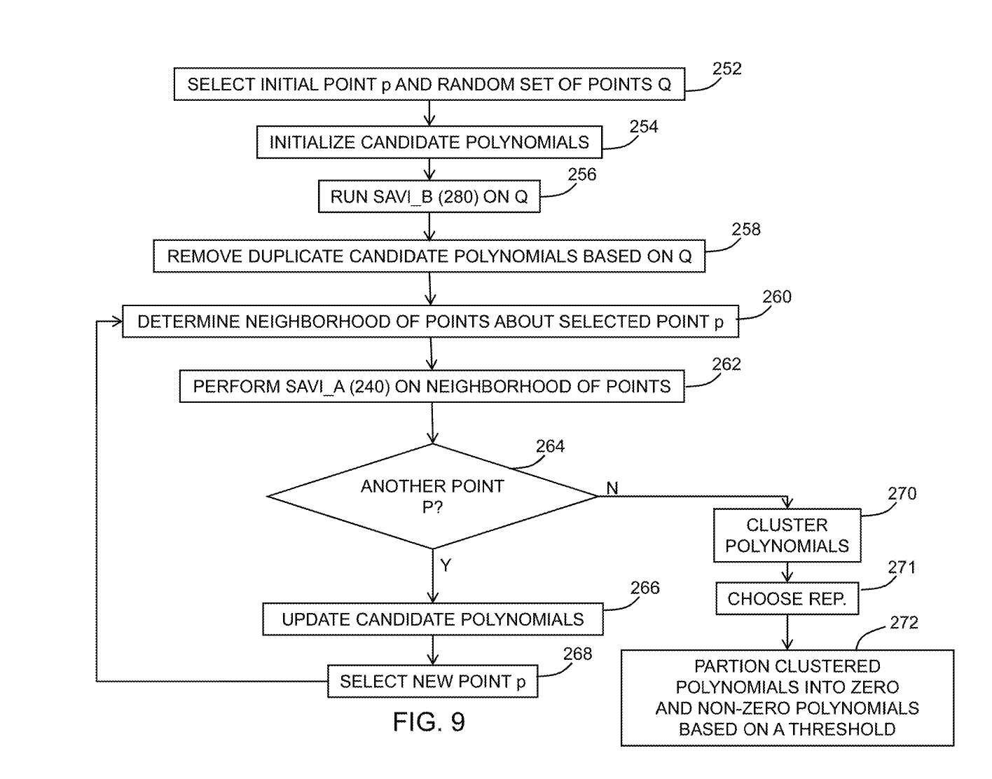

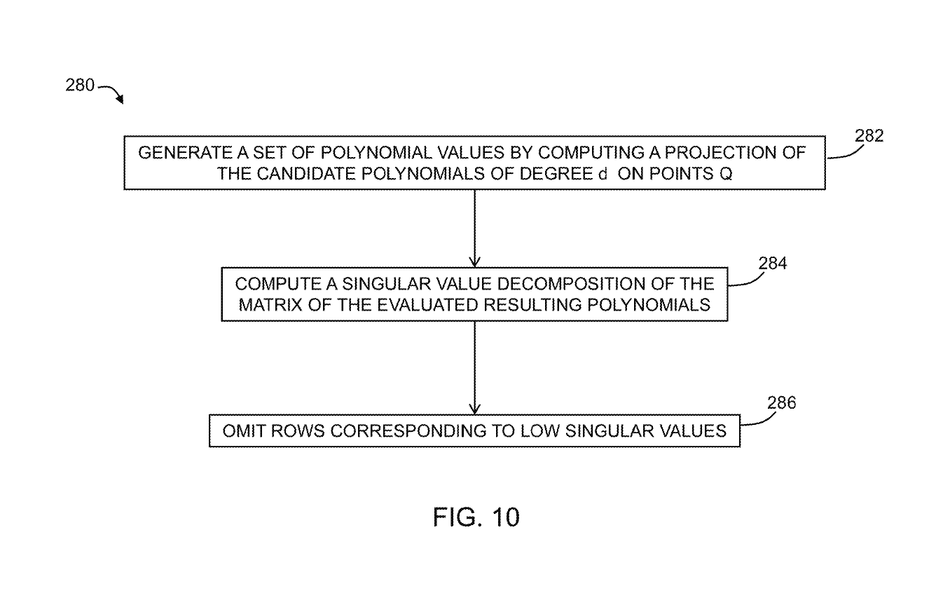

At 224, the method further includes determining (e.g., by the neighborhood determination engine 102) the neighborhood of data points about each selected point p, as described above. In one example, the neighborhood determination engine 102 determines the neighborhood by selecting data points within a threshold distance of the selected point p. At 226, a SAVI process 240 is performed on the neighborhood of data points about initial point p. This SAVI process 240 is designated as SAVI_A simply to differentiate from a slightly different SAVI_B process 280 described below in FIGS. 9 and 10. The SAVI process has been described above and is further illustrated as process 240 in FIG. 8.

Referring to FIG. 8, the SAVI_A process 240 includes operations 242, 244, and 246. Operation 242 is performed by the projection engine 104, while operations 244 and 246 are performed by the subtraction engine 106 and SVD engine 108, respectively.

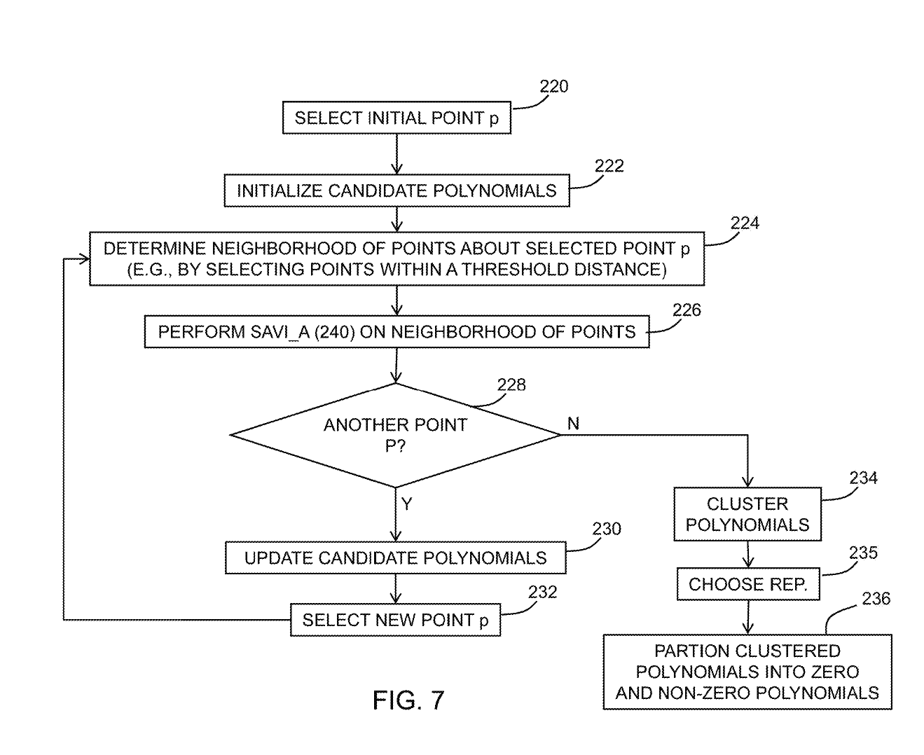

Operation 242 includes generating a projection set of polynomials by computing a projection set of space linear combination of the candidate polynomials of degree d (d=1 in this initial iteration of the method of FIG. 7) on polynomials degree less than d that do not evaluate on the neighborhood of data points to less than a threshold on the neighborhood of points.

At 244, SAVI_A process 240 includes subtracting the projection set of polynomials (from operation 242) evaluated on the neighborhood of data points from the set of candidate polynomials evaluated on the data points to generate a subtraction matrix of evaluated resulting polynomials.

At 246, the SAVI_A process 240 includes computing a singular value decomposition of the subtraction matrix of the evaluated resulting polynomials.

Referring back to FIG. 7, after SAVI_A process 240 is performed at 226, a determination is made as to whether additional data points exist in the plurality of data points being processed. If another data point exists, then the candidate polynomials are updated at 230 for use in processing the next neighborhood of data points. Updating the candidate polynomials may include building the candidate polynomials from the non-approximately zero polynomials described above. The next data point p is then selected at 232 and control loops back to 224. It does not matter which point p is selected next.

When all data points have been processed, then at 234 the polynomials computed for each neighborhood of data points are clustered (e.g., by clustering engine 110 as described above. At 235, a representative polynomial from each cluster is chosen. At 236, the chosen clustered polynomials are partitioned (e.g., by partitioning engine 112) into approximately zero polynomials and non-approximately zero polynomials.

Operations 224-232 may be repeated for higher dimension polynomials (2, 3, etc.) before clustering and partitioning the polynomials.

The candidate polynomials considered for each neighborhood of data points may include two or more polynomials that are duplicates. Such duplicates should be eliminated from consideration to make the process more efficient. In some implementations, the polynomials are represented by the various engines/modules in “concrete form,” that is in terms of their explicit mathematical representation. An example of concrete forms of polynomials include 2X̂3+4XŶ2-17X̂2Ŷ2+4Ŷ3.

Saving such concrete forms in storage, however, may create a significant burden on storage capacity. As such, in other implementations, rather than representing polynomials in concrete form, polynomials are represented based on an iterative algorithm. For each degree d, various SVD decompositions are performed as described above. Each polynomial constructed during the process described herein is constructed either by multiplying polynomials previously constructed, subtracting existing polynomials, multiplying by one the matrices in the SVD decomposition, or by taking several rows of the subtraction matrix. The information that is used to represent each polynomial thus may include the applicable SVD decompositions, the polynomials of the previous step in the process that were multiplied together, and which rows of the subtraction matrix correspond to the approximately zero polynomials and which rows do not correspond to the approximately zero polynomials.

With polynomials being represented in the form as described above, it may difficult to determine if two or more of such representations represent the same polynomial. That is, the same polynomial may be represented in multiple such forms. To eliminate multiple representations of the same polynomial, the method of FIG. 7 may be modified as described below in FIG. 9.

Referring to FIG. 9, many of the operations depicted are the same as in FIG. 7, but some operations have been added. The polynomial duplicate removal capability in the method of FIG. 9 is based on the processing of a random set of points Q using a modified SAVI process. The random set of points Q include points that are not part of the data points P. If two polynomials evaluate to the same value when provided with the same input points, then from a probabilistic viewpoint, such polynomials are likely to be duplicates. For example, each of two polynomials may be evaluated on each of 10 different input points. For each input point, if the resulting value from both polynomials is the same, then the two polynomials are likely duplicates.

The candidate polynomials for each neighborhood of data points are first evaluated on the random set of points Q. If any two candidate polynomial representations result in the same value for all points Q, then such representations are considered to be describing the same polynomials and are duplicates—one of such representations is thus removed from further consideration.

FIG. 9 refers to data points (p) and the random set of points Q. Data points p are the points for which polynomials are being determined, while points Q are used to identify and remove duplicate candidate polynomials.

At 252, an initial data point p is selected as well as the random set of points Q. Points Q may be previously determined and stored in non-transitory storage device 130 and thus selecting points Q may include retrieving the points Q from the storage device. At 254, the method of FIG. 9 includes initializing the candidate polynomials as described above. Operations 252 and 254 may be performed by the initialization engine 114.

At 256, a modified version of the SAVI_A process is run on the random set of points Q, and is referred to as the SAVI_B process 280. An example of the SAVI_B process 280 run on points Q is illustrated in FIG. 10.

Referring briefly to FIG. 10, SAVI_B process 280 is similar to the SAVI_A process 240 run on the data points p but only includes two of the three operations. Specifically, operation 282 includes generating a projection set of polynomials of the candidate polynomials of degree d (d=1 in this initial iteration of the method of FIG. 7). At 284, the SAVI_B process 280 includes computing a singular value decomposition of the resulting matrix of the evaluated resulting polynomials. At 286, rows from the subtraction matrix corresponding to low singular values (e.g., less than a threshold) are omitted.

At 258, the method includes removing duplicate candidate polynomials based on the random set of points Q and may be performed by the polynomial duplicate removal engine 116. In one example, the set of candidate polynomials are all evaluated on all of points Q and a determination is made as to whether any two (or more) polynomials evaluate to the same value for at least a threshold number of points Q (e.g., for at least 20 points Q). If so, such candidate polynomials are considered duplicates and one of such candidate polynomials is removed from further consideration.

Referring again to FIG. 9, operations 262-272 are the same as described above regarding operations 226-236 in FIG. 7 and thus are not again described.

Once the approximately-zero polynomials are determined for each class, the polynomials can be used to classify new data points. A module/engine may be included to receive a new data point to be classified and to evaluate all of the various approximately-zero polynomials on the data point to be classified. The new data point is assigned to whichever class's approximately-zero polynomials evaluate to approximately zero for the point (or at least less than the evaluations of all other classes' approximately-zero polynomials on the point).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
for each of a plurality of data points, determining, by executing a module stored on a non-transitory computer-readable storage device, a neighborhood of data points about each such data point;
for each such neighborhood of data points, generating a projection set of polynomials based on a plurality of candidate polynomials, subtracting the projection set of polynomials evaluated on the neighborhood of data points from the plurality of candidate polynomials evaluated on the neighborhood of data points to generate a subtraction matrix of evaluated resulting polynomials, and computing a singular value decomposition of the subtraction matrix;
clustering the evaluated resulting polynomials into multiple clusters; and
partitioning the evaluated resulting polynomials in each cluster based on a threshold.

2. The method of claim 1 further comprising selecting a random set of points Q.

3. The method of claim 2 further comprising removing duplicate candidate polynomials from the plurality of candidate polynomials based on Q.

4. The method of claim 2 further comprising removing duplicate candidate polynomials from the plurality of candidate polynomials by computing a projection set of a space linear combination of the plurality of candidate polynomials of degree d on polynomials of degree less than d that do not evaluate on Q to less than a threshold.

5. The method of claim 4 wherein removing the duplicate candidate polynomials also includes computing a singular value decomposition of the subtraction matrix of evaluated resulting polynomials.

6. The method of claim 1 wherein determining the neighborhood of points includes selecting points within a threshold distance of said such data point.

7. A system, comprising:
a neighborhood determination engine to determine, for a given data point, a neighborhood of points about the given data point;
a projection engine to generate a projection set of polynomials of a space linear combination of candidate polynomials
a subtraction engine to subtract the projection set of polynomials evaluated on the neighborhood of points from the set of candidate polynomials evaluated on the neighborhood points to generate a subtraction matrix of evaluated resulting polynomials;
a singular value decomposition engine to compute a singular value decomposition of the subtraction matrix;
a clustering engine to cluster the evaluated resulting polynomials into multiple clusters; and
a partitioning engine to partition the polynomials within each cluster based on a threshold.

8. The system of claim 7 further comprising an initialization engine to select a set of points Q that is not the data points.

9. The system of claim 8 further comprising a polynomial duplicate removal engine to remove duplicate candidate polynomials based on Q.

10. The system of claim 8 further comprising a duplication removal engine to remove duplicate candidate polynomials by computing a projection set of a space linear combination of the candidate polynomials of degree d on polynomials of degree less than d that do not evaluate on Q to less than a threshold.

11. The system of claim 10 wherein the duplicate removal engine is to remove the duplicate candidate polynomials by computing a singular value decomposition of the subtraction matrix of evaluated resulting polynomials.

12. The system of claim 7 wherein the neighborhood determination engine is to determine the neighborhood of points by selecting points within a threshold distance of the given data point.

13. A non-transitory storage device containing software that, when executed by a processor, causes the processor to:
obtain a random set of points Q;
remove duplicate candidate polynomials from a set of candidate polynomials based on Q;
for each of a plurality of data points, determine a neighborhood of data points about each such data point;
for each such neighborhood of data points, generate a projection set of polynomials based on the candidate polynomials with duplicates removed, subtract the projection set of polynomials evaluated on the neighborhood of points from the set of candidate polynomials evaluated on the neighborhood of points to generate a subtraction matrix of evaluated resulting polynomials, and compute a singular value decomposition of the subtraction matrix of evaluated resulting polynomials;
cluster the evaluated resulting polynomials into multiple clusters; and
partition the evaluated resulting polynomials in each cluster based on a threshold.

14. The non-transitory storage device wherein the software, when executed, further causes the computer to remove duplicate candidate polynomials by computing a projection set of a space linear combination of the candidate polynomials of degree d on polynomials of degree less than d that do not evaluate on Q to less than a threshold

15. The non-transitory storage device wherein the software, when executed, further causes the computer to determine the neighborhood of data points by selecting points within a threshold of each such data point.
